(19) United States
(12) Patent Application Publication
(10) Pub. No.: US 2017/0228035 A1
(43) Pub. Date: Aug. 10, 2017

(54) SYSTEM AND METHOD FOR CONTROLLING A PIECE OF EQUIPMENT OF A MOTOR VEHICLE

(71) Applicant: VALEO COMFORT AND DRIVING ASSISTANCE, Créteil (FR)

(72) Inventors: Michael Irzyk, Creteil (FR); Frédéric Autran, Creteil (FR)

(73) Assignee: VALEO COMFORT AND DRIVING ASSISTANCE, Créteil (FR)

(21) Appl. No.: 15/514,992

(22) PCT Filed: Sep. 29, 2015
(86) PCT No.: PCT/FR2015/052592

§ 371 Date: Mar. 28, 2017

(30) Foreign Application Priority Data
Sep. 30, 2014 (FR) 1402203

(51) Int. Cl. G06F 3/01; B60H 1/00; B60K 35/00; G06F 3/147; G06K 9/00

(52) U.S. Cl. CPC G06F 3/017; G06F 3/147; G06K 9/00355; B60K 35/00; B60H 1/00735; B60K 2350/352; B60K 2350/921; B60K 2350/1052; B60K 2350/106; B60K 2350/2052

(57) ABSTRACT

The system is characterised in that, the vehicle comprising a head-up-type display (34), said system comprises a gesture recognition device (26) that can supply data representative of a gesture made by the driver of the vehicle, and a control module (28) for processing the data, the control module (28) being designed so as to be able to control the display of at least one visual feedback (30, 32) on the display, upon reception of said data representative of the gesture made by the driver.

### 1. TECHNICAL FIELD

The invention relates to a system for controlling at least one piece of equipment of a motor vehicle.

A conventional motor vehicle is provided with many pieces of equipment and functions for improving the comfort or safety of the driver, including, for example, a heating and air conditioning system, a car radio, a hands-free telephone device, a geolocation and road navigation system, and the like. The multiplication of these pieces of equipment leads to a multiplication of the number of controls in the vehicle designed to regulate or configure these multiple functions and pieces of equipment, the controls usually taking the form of push buttons, knobs, and the like.

The large number of controls present near the steering wheel, near the dashboard, or in the central part of the passenger compartment may give rise to safety problems, because the driver has to look away from the road in order to find the control relating to the function or equipment that the driver wishes to adjust, and then to carry out the adjustment of the control according to the adjustment that he desires.

In the present state of the art, gesture recognition devices cannot reliably recognize the gestures made, partly because of the recognition technologies used and partly because of the imprecision of the gestures made by the driver. Consequently the operation of these devices fails to meet the requirements of safety and comfort of the driver.

### 2. OBJECTS OF THE INVENTION

The invention is intended to overcome at least some of the drawbacks of the known motor vehicle control systems.

In particular, the invention is also intended to provide a control system comprising a gesture recognition device for informing the driver of the correct or incorrect recognition of a gesture made by him.

The invention is also intended to provide a control system which enables the driver to adjust equipment and functions of the vehicle without looking away from the road.

### 3. SUMMARY OF THE INVENTION

For this purpose, the invention relates to a system for controlling at least one piece of equipment of a motor vehicle, the vehicle comprising a display device of the head-up type, said system comprising a gesture recognition device, capable of supplying data representative of a gesture made by a driver of the vehicle, and a control module capable of processing said data, characterized in that the control module is configured to control the display of at least one piece of visual feedback on the display device when it receives said data representative of the gesture made by the driver.

The term “gesture” is taken to mean both a sign in the sense of a particular static position, and a gesture in the sense of a movement in space.

The term “visual feedback” is taken to mean information to be displayed to the driver on the display device, enabling the driver to be informed of the correct recognition of the gesture made.

The invention also enables the driver to benefit from visual feedback concerning the recognition or non-recognition of the gesture made, in order that the driver does not erroneously think that his gesture has not been recognized by the system when it has actually been recognized, and does not erroneously think that his gesture has been recognized by the system when it has not been recognized. The invention may also be used to compensate for the inaccuracies of a prior art system, caused either by the detection of the gesture or by the actual execution of the gesture by the driver.

Additionally, since this visual feedback is provided on the heads-up display, the driver may control his equipment without looking away from the road.

Advantageously and according to the invention, the gesture recognition device is capable of supplying data representative of a gesture made by the vehicle driver's hand.

According to this aspect of the invention, the gesture recognition takes place in relation to the driver's hand, which is one of the parts of the driver's body that is easiest to recognize for the purposes of gesture recognition. Furthermore, the hand may easily be used to make many signs (hand closed, hand open, different combinations of bent/open fingers, etc.) and various gestures (in the three dimensions of space). Finally, by using his hand, the driver can make gestures without looking away from the road.

Advantageously and according to this last aspect of the invention, the control module is configured to control the display of a piece of visual feedback, called the first visual feedback, on the display device, when it receives data representative of the detection of the presence of the driver's hand by the gesture recognition device.

According to this aspect of the invention, this first visual feedback enables the driver, before he even makes a gesture, to know whether the presence of his hand is detected, so that he can be sure that a potential gesture made subsequently can be recognized. This is because, if the driver makes a gesture when his hand is not detected, he cannot know whether it is his hand or the gesture that has not been detected. This first visual feedback enables this problem to be overcome.

Advantageously and according to the invention, the control module is configured to control the display of a help image on the display device, to inform the driver of various types of gesture that can be recognized by the gesture recognition device.

According to this aspect of the invention, the driver can benefit from a help image which reminds him of all or some of the gestures that he can make and that will be recognized by the gesture recognition device. This help image appears only when the driver's hand is detected, in order to avoid annoying the driver at other times by displaying the available gestures on the display device, which might overcrowd this device.

Advantageously and according to the invention, the control module is configured to control the display of a piece of visual feedback, called the second visual feedback, on the display device, when it receives data representative of the recognition of a type of gesture made by the driver from among a plurality of types of gesture that can be recognized by the gesture recognition device.

According to this aspect of the invention, the control module provides information on the detection of a gesture made by the driver, by using the second visual feedback. This gesture has a meaning only if it forms part of a gesture recognized by the gesture recognition device, and therefore if it is included in the types of gesture that this device can recognize. The display module therefore confirms to the driver that the gesture made by him has been correctly recognized.

Advantageously and according to the invention, the control module is configured to control the display of the first visual feedback and the second visual feedback.

According to this aspect of the invention, the driver may make a gesture while knowing:
whether his hand has actually been detected, so that he can avoid making a gesture which will not be detected if his hand has not been detected, and
whether the gesture has actually been detected, so that he can avoid repeating his gesture several times without knowing whether or not it has been detected.

This combination can greatly increase the efficiency of the driver's gestures, to prevent the driver from losing his concentration on the road and his journey by making unnecessary gestures if the detection is unsuccessful, or if detection has taken place without the confirmation of visual feedback, which would lead him to repeat unnecessarily a gesture that had already been recognized.

Advantageously and according to the invention, the control module is configured to control at least one piece of equipment of the vehicle, said equipment being associated with a type of gesture made by the driver from among a plurality of types of gesture that can be recognized by the gesture recognition device.

According to this aspect of the invention, the control module receives the data from the recognition device, and enables both the display of the visual feedback on the display device and the transmission of the control signals toward the vehicle's equipment to perform the actions associated with the detected gestures.

Advantageously and according to the invention, the control module comprises a database comprising the types of gesture that can be recognized by the gesture recognition device.

Advantageously and according to the invention, the gesture recognition device comprises a contactless detector configured to detect the gesture made by the driver.

Advantageously and according to this last-mentioned aspect of the invention, the contactless detector is one of the following detectors, or a combination of them:
a video camera,
a time-of-flight camera,
an ultrasonic detector,
an infrared detector,
a capacitive detector.

Advantageously and according to the invention, the control module is configured to control at least one piece of equipment from among the following equipment:
a vehicle air conditioning/heating system,
a car radio of the vehicle,
a hands-free telephone device,
a geolocation and road navigation system, such as a GPS system.

The invention also concerns a method for controlling at least one piece of equipment of a motor vehicle, characterized in that, the vehicle comprising a display device of the head-up type, said method comprises, in succession, a step of recognizing a gesture made by the driver of the vehicle, a step of transmitting data representative of said gesture, a step of processing said data, and a step of controlling the display on the display device of at least one piece of visual feedback representative of the data processed in the processing step.

Advantageously, the method according to the invention is executed by the system according to the invention.

Advantageously, the system according to the invention executes the method according to the invention.

### 4. DESCRIPTION OF THE DRAWINGS

Other objects, characteristics and advantages of the invention will be apparent from a perusal of the following description, provided in a purely non-limiting way, which refers to the attached drawings, in which:

FIG. 1 is a schematic representation of a vehicle interior provided with the control system according to an embodiment of the invention,

FIG. 2 is a schematic representation of a control system according to an embodiment of the invention,

FIG. 3 is a schematic representation of a control method according to an embodiment of the invention.

### 5. DETAILED DESCRIPTION OF AN EMBODIMENT OF THE INVENTION

It should be noted that the figures show the invention in a detailed manner for the purpose of applying the invention, said figures obviously being usable to define the invention more closely if necessary.

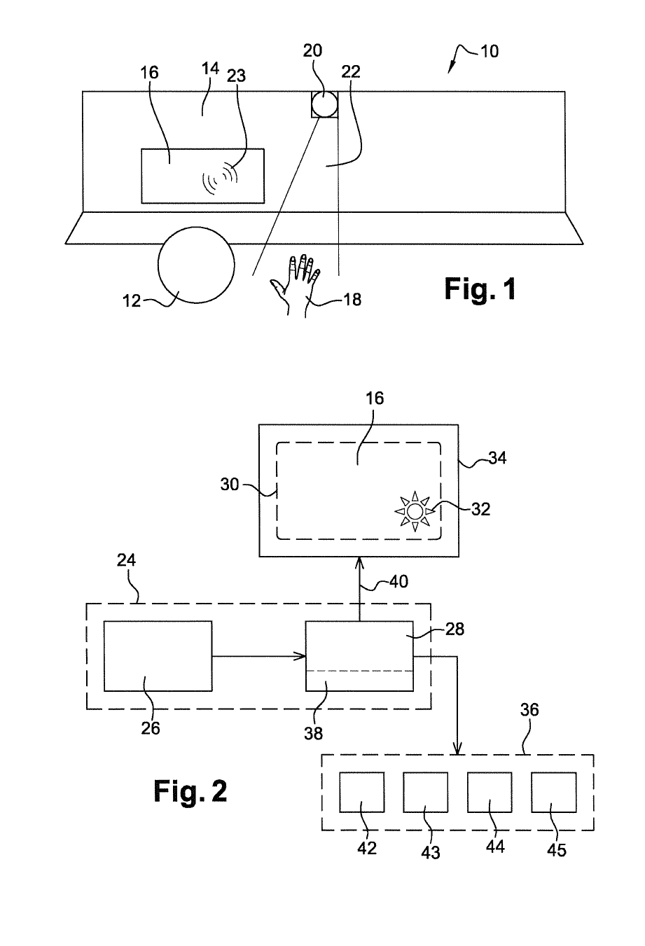

FIG. 1 is a schematic representation of a vehicle interior 10 provided with a system according to the invention. The driver of the vehicle is represented by his head 12, facing a front windshield 14 of the vehicle, on which an image 16 is displayed by a head-up display. In this case the image 16 is displayed directly on the windshield 14, but it could be, for example, displayed on a semi-transparent screen placed between the driver 12 of the vehicle and the windshield 14.

In the context of the invention, and for the purpose of controlling different pieces of equipment of the vehicle, such as the air conditioning/heating, the car radio or a hands-free telephone device, the driver 12 may use his hand 18 to make different gestures and/or signs (both covered by the term “gesture”). Each gesture is associated with a piece of equipment and/or a control signal to be transmitted to this equipment, for example to switch the air conditioning/heating on or off, to raise or lower the temperature, to answer a telephone call, etc. The use of the hand 18 of the driver 12, rather than another part of his body (head, eye following, etc.), enables the driver 12, notably, to make the gestures without looking away from the road.

The gestures are recognized by a gesture recognition device, installed in the vehicle 10. This gesture recognition device comprises a contactless detector 20, for example a camera (a video camera or a time-of-flight camera), an ultrasonic or infrared detector, a capacitive detector, or the like (or a combination of these last-mentioned examples), placed, for example, as shown in FIG. 1, at the top and center of the windshield. FIG. 1 also shows the field of view 22 of the camera 20, in which the hand 18 of the driver 12 is placed when the system is used according to this embodiment of the invention.

According to the invention, the recognition of the gestures of the driver 12 by the gesture recognition device causes data to be transmitted to a control module which can, in turn, control the display of a piece of visual feedback 23 on the display device.

FIG. 2 is a schematic representation of a control system 24 according to an embodiment of the invention, comprising the gesture recognition device, identified by 26, and the control module, identified by 28. The gesture recognition device 26, comprising the detector 20 of FIG. 1, transmits data representative of the gesture made by the driver 12 of the vehicle to the control module 28. The control module 28 can then control the display of visual feedback 30 or 32 on a display device 34, and can also control one or more pieces of equipment 36 of the vehicle.

In practice, the gesture recognition device 26 and the control module 28 may be two separate components or may form part of the same component, such as a computer for example, the control module 28 being, for example, a module installed in software form in the computer.

The gesture recognition device 26 makes it possible to recognize the hand 18 of the driver 12 detected by the detector 20, and to recognize any gesture made by this hand. The representative data transmitted by the recognition device 26 contain information enabling the control module 28 to control the display of the visual feedback 30, 32 on the display device 34 and to control the equipment 36. In various embodiments of the invention, the data sent by the recognition device 26 are similar to raw data, such as the depth data obtained from a time-of-flight camera, which is interpreted by the control module 28 in order to execute its control signals; alternatively, the recognition device 26 sends richer data that it has itself partially interpreted, for example the type of gesture recognized, the time during which the gesture was made, or the like.

The control module 28 translates these recognized gestures into control signals, both for controlling the display of one or more pieces of visual feedback 30, 32 on the display device 34 and for controlling the equipment 36. For the association of each gesture with a control signal, the control module 28 advantageously comprises a database 38 comprising the different types of gesture that can be recognized by the gesture recognition device 26. Each gesture is associated with a function or a piece of equipment 36, preprogrammed by the vehicle manufacturer or recorded by a user of the vehicle during a system configuration.

The control module 28 then transmits the control signals. The control signal for visual feedback sent to the display device is transmitted by the link 40 (which may be either wired or wireless). On receiving this control signal, the display device 34 displays the piece or pieces of visual feedback 30, 32. For example, this visual feedback 30, 32 may be:
A first visual feedback 30, for informing the driver 12 of the correct recognition by the gesture recognition device 26 of the presence of the hand 18 of the driver 12. This enables the driver 12 not to make a gesture until his hand 18 has been detected by the recognition device 26. Advantageously, this first visual feedback 30 is discreet in order to avoid overcrowding the image 16 displayed by the display device 34; for example, it may be a diffused halo or an illuminated contour surrounding the whole image 16 displayed on the display device 34, making it possible to provide visual feedback which is not superimposed on other information in the image 16 on the display device 34. In FIG. 2, the first visual feedback 30 is represented by a dotted rectangle with rounded corners which extends along the contour of the display device, as the diffused halo or illuminated contour might do.
A second visual feedback 32 can inform the driver 12 of the correct recognition of a gesture made which is one of the gestures that the gesture recognition device 26 can recognize. Advantageously, an icon representative of the equipment 36 associated with this gesture is displayed as a second visual feedback 32. For example, in FIG. 2, the second visual feedback 32 is represented by an icon of a sun which may correspond to the equipment of the vehicle responsible for the heating, and which enables the driver 12 to check that the detected control signal is the one he intended when making the gesture.

To ensure that the driver 12 does not forget the type of gestures that he can make to control the equipment 36, the first visual feedback 30 may be accompanied by a display of the available gestures, using a help image provided with icons representing a hand making a gesture, and if necessary with an icon representing the equipment associated with this gesture. This help image may be displayed as soon as the hand is detected, or after a time delay, preferably of between 3 and 4 seconds.

The other control signal transmitted by the control module 28 is the control signal to be sent to one or more pieces of equipment 36 associated with the type of gesture made by the driver. Examples of equipment 36 that may be controlled by the control module 28 of the system 24 are, for example, an air conditioning/heating system 42, a car radio 43, a hands-free telephone device 44, a geolocation and road navigation system 45, and the like. A gesture may control more than one piece of equipment 36 simultaneously; for example, a control signal activating the air conditioning/heating 42 may also control the closure of the windows of the vehicle.

The control signals to this equipment 36 may be executed in two stages: the driver may make a sign, in the sense of a particular static position, and/or a gesture, in the sense of a movement in space. The sign may be associated with the equipment 36 that is to be controlled, and the gesture made after the recognition of this sign may execute a particular function associated with this equipment. For example, an open hand (that is to say, with all five fingers open) may be a sign associated with the heating/air conditioning 42, and a gesture of upward movement then indicates that the driver 12 wishes to increase the temperature, whereas a downward gesture indicates that the driver 12 wishes to lower the temperature.

Other examples of signs, their associated equipment and the available functions are:
air conditioning/heating 42: sign: open hand; functions: switch on, switch off, raise/lower temperature, recycle air, etc.
car radio 43: sign: closed fist; functions: silence, raise/lower volume, change radio station, etc.
hands-free telephone device 44: sign : thumb and index finger open; functions : silence, pick up a call, hang up a call, etc.

As a general rule, the gestures associated with the functions should be simple, to avoid any distraction of the driver 12. For example, a movement from right to left may be used to pick up a call, while a movement from left to right may be used to hang up a call.

In a similar manner to the help image enabling the driver 12 to be informed of the gestures associated with each piece of equipment, a help image on the display device 34 may also serve to inform the driver 12 of the gestures associated with the functions of the chosen equipment.

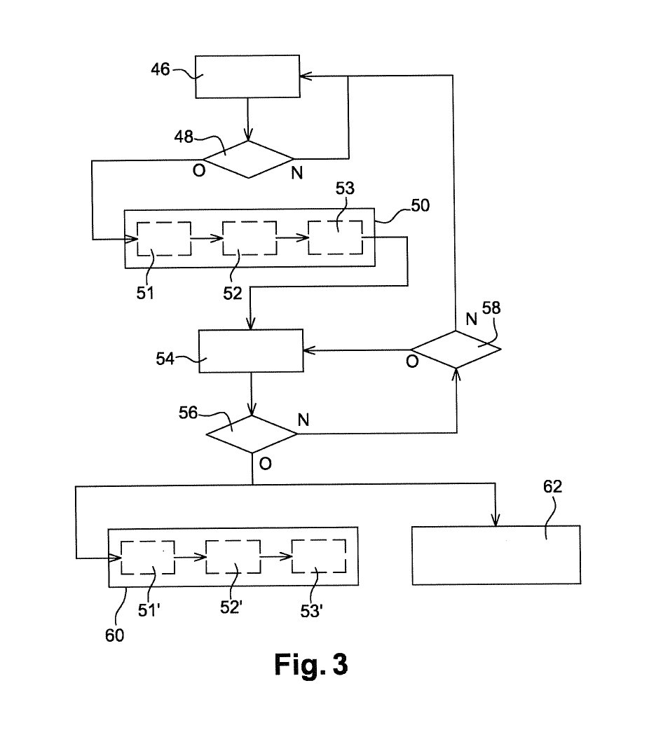

FIG. 3 is a schematic representation of a method according to an embodiment of the invention, in the form of a flow diagram comprising steps linked to the actions of the driver 12. The first step is an initial rest state 46, where the method associated with the system has not been launched, and no action is performed by the system. This first step is linked to a step 48 of detecting the hand, in the form of a decision box comprising the test: “has the hand 18 of the driver 12 been detected?”. If the answer is no (represented by the letter N), the method loops to the initial state 46, and if the answer is yes (represented by the letter O), the method enters a step 50 of controlling the first visual feedback. The test is linked to the detection of the hand 18 by the gesture recognition device 26, not to the actual presence of the hand 18: if the driver 12 places his hand 18 in front of the recognition device 26 but it is not detected, the method loops to the initial state 46 until detection has taken place.

Step 50 of controlling the first visual feedback then enables the driver to be informed that his hand has actually been detected. This control step comprises a step 51 of transmitting representative data, supplied by the gesture recognition device 26, to the control module 28; a step 52 of the processing of said data by the control module 28; and a step 53 of controlling the display on the display device 34 of the first visual feedback 30, corresponding to the detection of the presence of the hand 18 of the driver 12.

This step 50 of controlling the first visual feedback is followed by a step 54 of waiting for the gesture made by the driver 12. It is linked to a step 56 of recognizing said gesture made by the driver 12 from among a plurality of types of gesture that the gesture recognition device 26 can recognize, this step taking the form of a decision box comprising the test: “has a gesture of the known hand 18 been detected?”. If the answer is no, the method enters a step 58 of checking for the presence of the hand 18. If the answer is yes, the method executes two simultaneous control steps, namely a step 60 of controlling the second visual feedback 32 and a step 62 of controlling the equipment 36.

In a more general sense, step 48 of detecting the hand and step 56 of recognizing the gesture made by the driver 12 from among a plurality of types of gesture that the gesture recognition device 26 can recognize are two forms of a step of recognizing the gesture made by the driver within the method according to the invention.

Step 58 of checking for the presence of the hand 18 may be used to check whether the hand 18 of the driver 12 is still detected by the recognition device 26. If this is the case, the method loops to the waiting step 54; otherwise it returns to the initial state 46.

The two control steps are performed simultaneously in this embodiment: step 60 of controlling the second visual feedback 32 is similar to step 50 of controlling the first visual feedback: it comprises a step 51′ of transmitting representative data, supplied by the gesture recognition device 26, to the control module 28, a step 52′ of the processing of said data by the control module 28, and a step 53′ of controlling the display on the display device of the second visual feedback 32, corresponding to the detection of a gesture made by the driver 12.

Step 58 of controlling the equipment 36 corresponds to the sending of a control signal by the control module 28 to the piece or pieces of equipment 36 associated with the detected gesture.

1. A system for controlling at least one piece of equipment of a motor vehicle, the vehicle comprising a display device of the head-up type, said system comprising:
a gesture recognition device for supplying data representative of a gesture made by a driver of the vehicle; and
a control module for processing said data,
wherein the control module is configured to control the display of at least one piece of visual feedback on the display device when said data representative of the gesture made by the driver is received.

2. The control system as claimed in claim 1, wherein the gesture recognition device supplies data representative of a gesture made by a hand of the vehicle driver.

3. The control system as claimed in claim 2, wherein the control module is configured to control the display of a first visual feedback, on the display device, when data representative of the detection of the presence of the hand of the driver is received by the gesture recognition device (26).

4. The control system as claimed in claim 1, wherein the control module is configured to control the display of a help image on the display device, to inform the driver of a plurality of types of gestures recognized by the gesture recognition device.

5. The control system as claimed in claim 1, wherein the control module is configured to control the display of a second visual feedback, on the display device when data representative of the recognition of a type of gesture made by the driver from among a plurality of types of gestures recognized by the gesture recognition device is received.

6. The control system as claimed in claim 1, wherein the control module is configured to control at least one equipment of the vehicle, said at least one equipment being associated with a type of gesture made by the driver from among a plurality of types of gestures recognized by the gesture recognition device.

7. The control system as claimed in claim 4, wherein the control module comprises a database comprising the types of gestures recognized by the gesture recognition device.

8. The control system as claimed in claim 1, wherein the gesture recognition device comprises a contactless detector configured to detect the gesture made by the driver.

9. The control system as claimed in claim 8, wherein the contactless detector is at least one selected from a group consisting of:
a video camera,
a time-of-flight camera,
an ultrasonic detector,
an infrared detector, and
a capacitive detector.

10. The control system as claimed in claim 1, wherein the control module is configured to control at least one equipment from a group consisting of:
a vehicle air conditioning/heating system,
a car radio of the vehicle,
a hands-free telephone device, and
a geolocation and road navigation system.

11. A method for controlling at least one equipment of a motor vehicle, the vehicle comprising a display device of a head-up type, said method comprising, in succession:
recognizing a gesture made by a driver of the vehicle;
transmitting data representative of said gesture;
processing said data representative of said gesture; and
controlling the display on the display device of at least one piece of visual feedback representative of the processed data representative of said gesture.
